(19) United States
(12) Patent Application Publication
(10) Pub. No.: US 2009/0307276 A1
(43) Pub. Date: Dec. 10, 2009

(54) MIGRATION USING FILE SYSTEM LINKS

(75) Inventors: Terrance James Dolan, IV, Issaquah, WA (US); James Schmidt, Plymouth, MI (US); Vijayendra G. Vasu, Hyderabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/134,206

(22) Filed: Jun. 6, 2008

(51) Int. Cl. G06F 12/00; G06F 17/30

(52) U.S. Cl. 707/202; 707/204; 707/E17.01; 711/E12.001

(57) ABSTRACT

User state migration using file system hard links system and method. A file system hard link refers to a directory entry for a file that allow a file to be referenced by two or more separate filenames, without data of the file being stored in two or more places.

A user state gather component receives information associated with user state (e.g., file and, optionally, setting(s)). The user state gather component stores a hard link to the file in a user state store. A user state apply component restores user state based on the hard link to the file stored in the user state store. For example, the user state apply component can restore user state once an operating system has been installed. Optionally, the system includes a plurality of user state stores that are linked together.

### BACKGROUND

Computer administrator(s) (e.g., enterprise IT engineer(s)), on occasion, change and/or refresh an operating system installed on a user's computer, for example in order to derive benefits associated with a newer operating system, to recover from an incurable virus infection, etc. Changing the operating system on a computer can be accomplished via an in-place upgrade and/or a wipe-and-load operation.

An in-place upgrade generally leaves data and applications installed on the computer unchanged. That is, only the operating system is changed. Wipe-and-load refers to a process during which the information on a hard drive of the computer is wiped clean (e.g., data, application(s) and the operating system). The operating system is then installed on the cleaned computer with data and application(s) subsequently installed.

Wipe-and-load involves erasing the entire hard drive. However, “erasing” can have two forms, literal and perceived. For example, a wipe-and-load can move files into a backup store that remains on the drive. Because the files are not in original locations, the files appear to be erased. Similarly, while data on non-system drives would normally not be erased, a clean install operating system can lack linkage to other drives (e.g., such as redirected My Documents folder in the shell) which an end user would also perceive as an erase effect.

It can be desirable to capture changes that a user has made to the operating system and/or applications, as well as the user's documents (e.g., files, pictures, etc.) from the previously installed operating system and transfer the changes to the newly installed operating system. This set of operating system and application changes coupled with user documents is typically referred to as “user state”. Transferring the user state from the previously installed operating system to the newly installed operating system can help reduce disruptions in end user productivity throughout the wipe-and-load process.

Conventionally, the process of performing a wipe-and load was performed by first capturing user state from the previously installed operating system and copying it to a temporary location (e.g., a folder located on a file server and/or on the computer). The hard drive was then wiped, except the temporary folder, if used.

The new operating system was then installed. Thereafter, desired application(s) were installed. User state was then restored from the temporary location to the newly installed operating system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosed systems and methods facilitate user state migration using file system hard links. The use of hard links to files during a user state migration can bring performance and disk space usage benefits which are metrics for a user state migration tool.

A file system hard link refers to a directory entry for a file. Hard links allow a file to be referenced by two or more separate filenames, without the file's data being stored in two places.

A system that facilitates user state migration includes a user state gather component that receives information associated with user state. The user state includes a file and can, optionally, include setting(s) and the like. The user state gather component stores a hard link to the file in a user state store. Optionally, the user state gather component can create the user state store on a volume associated with the file.

Since a hard link is a directory entry, the hard link consumes very little disk space and creation of the hard link is very quick when compared to the space and time considerations associated with creating and copying a file. Further, the time and space to create a hard link to a file are independent of the size of the file. Creating a hard link to a user document in the user state store, instead of copying the entire document into the user state store, provides a significant improvement in the time and space efficiency of user state migration.

The system further includes a user state apply component that restores user state based on the hard link to the file in the user state store. For example, the user state apply component can restore user state once a different installed operating system has been installed.

Optionally, the system includes a plurality of user state stores that are linked together. For example, there can be a user state store for each volume having one or more files to be migrated.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates user state migration.

FIG. 2 illustrates a computer-implemented system that facilitates operating system modification.

FIG. 3 illustrates a computer-implemented system that facilitates user state migration.

FIG. 4 illustrates a computer-implemented system that facilitates user state migration.

FIG. 5 illustrates a method of performing user state migration.

FIG. 6 illustrates a method of gathering user state.

FIG. 7 further illustrates the method of FIG. 6.

FIG. 8 illustrates a computing system operable to execute the disclosed architecture.

FIG. 9 illustrates an exemplary computing environment.

### DETAILED DESCRIPTION

The disclosed systems and methods facilitate user state migration using file system hard links. Through the use of file system hard links, temporary storage space associated with user state migration for operating system modification can be reduced.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

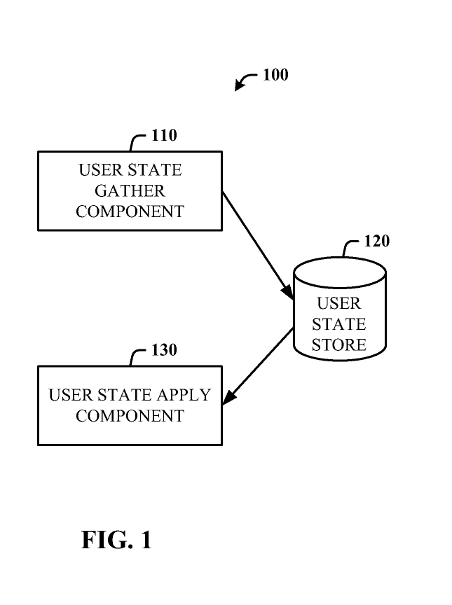

Referring initially to the drawings, FIG. 1 illustrates a computer-implemented system 100 that facilitates user state migration using file system hard links. The use of hard links to files during a user state migration can bring performance and disk space usage benefits which are metrics for a user state migration tool.

File system hard link(s) refers to a directory entry for a file. Hard links allow a file to be referenced by two or more separate filenames, without the file's data being stored in two places.

As noted previously, conventionally, a change to an operating system of a computer was accomplished by in-place upgrade or wipe-and-load. The process of performing a wipe-and load was performed by first capturing user state from the previously installed operating system and copying it to a temporary location (e.g., a folder located on a file server and/or on the computer associated with the operating system change). The hard drive was then wiped, except the temporary folder, if used.

There are several disadvantages associated with copying user state to a folder located on a file server (e.g., temporary store on a network file server). First, a sufficiently large network location (e.g., often several gigabytes) is used. Often several computers are simultaneously performing a wipe-and-load operation which can result in large amounts of data temporarily stored on the file server.

Second, transmission of data to the file server across the network consumes valuable bandwidth. Third, since user state can contain sensitive data, it is common to encrypt the data before it moves across the network which necessitates that encryption key(s) be managed and stored.

Likewise, there are several disadvantages associated with conventional copying user state to a temporary location on the computer associated with the operating system change. First, a similarly sufficiently large location (e.g., often several gigabytes) is used. Placing user state (e.g., contents of file(s) and/or setting(s)) in the temporary location on the computer takes a great deal of time.

The system 100 includes a user state gather component 110 that receives information associated with user state. The user state includes a file and can, optionally, include setting(s) and the like. The user state gather component 110 creates a hard link to the file in a user state store 120. Optionally, the user state gather component 110 can create the user state store 120 on a volume associated with the file.

Through the use of file system hard links, temporary storage space associated with user state migration for operating system modification can be reduced. Additionally, a time to store hard links to file(s) in the user state store 120 can be significantly less than copying of contents of the file(s).

In many senses, the differences between copying a file and creating a hard link to a file are analogous to the programming concepts of passing a variable by value during a function call or passing a pointer to a value during a function call. Copying a file can be thought of as passing a variable by value. Both functions have an independent copy of the value. Conversely, creating a hard link is similar to passing a pointer to a function. Neither function has a copy, but both functions can retrieve a value based on the pointer.

For example, in the Windows NT® File System (“NTFS”), a file system link (e.g., hard link) is a directory entry for a file. A file can be considered to have at least one hard link. On NTFS volumes, a file can have multiple hard links, and thus the file can appear in one or more directories and/or even in the same directory with different names.

Programs can use a hard link to a file like any other file name. Because the links reference the same file, a program can open any of the links and modify the file. A file is deleted from the file system once the links to it have been deleted.

Those skilled in the art will recognize that other types of hard links exist in file systems of operating systems other than Windows NT®. All such types of hard links are intended to be encompassed by the hereto appended claims.

Since a hard link is a directory entry, the hard link consumes very little disk space and creation of the hard link is quick when compared to the space and time considerations associated with creating and copying contents of a file. Further, the time and space to create a hard link to a file are independent of the size of the file. Thus, creating a hard link to a user document in the user state store 120, instead of copying the entire document into the user state store 120, provides a significant improvement in the time and space efficiency of user state migration.

Hard links are different from shortcuts as a shortcut is a separate file that contains a path to a file pointed to by the shortcut. If the file pointed to by the shortcut is moved, renamed and/or deleted, the shortcut becomes invalid. As a result, shortcuts cannot effectively be used as an alternative to copying files into a temporary store. If a shortcut to a user document is created in the temporary store, when the computer is wiped clean, the shortcuts become invalid. In contrast, if a hard link to the user document is created in a user state store 120 (e.g., a temporary store) and the document is deleted from its original location, the file continues to exist and is referenced through the link created in the user state store 120.

The system 100 further includes a user state apply component 130 that restores user state based on the hard link to the file in the user state store 120. For example, the user state apply component 130 can restore user state once a different installed operating system has been installed. In one embodiment, the user state store 120 includes a combination of hard file links and copied files.

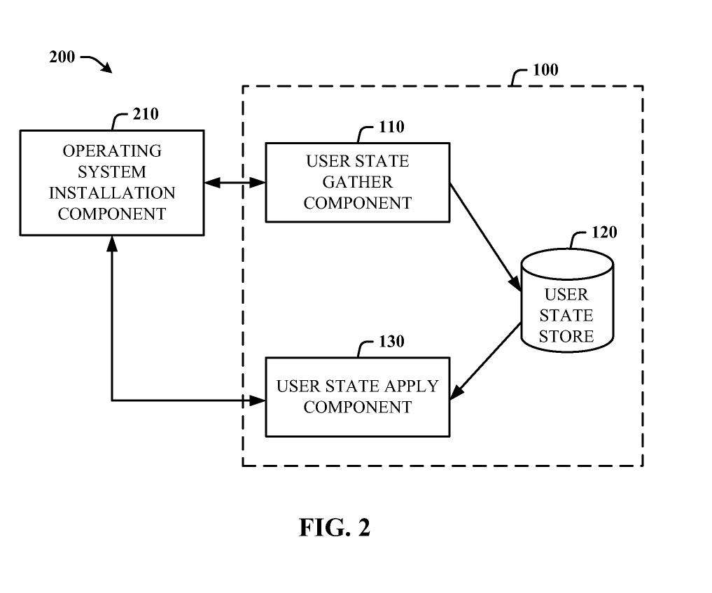

Turning to FIG. 2, a computer-implemented system 200 that facilitates operating system modification is illustrated. The system 200 includes an operating system installation component 210 and a user state migration system 100. In one example, the system 200 can be invoked via a command line.

The operating system installation component 210 initiates gathering of user state by the user state gather component 110. Once user state has been gathered, the operating system installation component 210 installs an operating system (e.g., reinstallation of current operating system, installation of a different version of current operating system, installation of a different operating system, etc.). Once the operating system has been installed, the operating system installation component 210 initiates applying of the previously stored user state by the user state apply component 130.

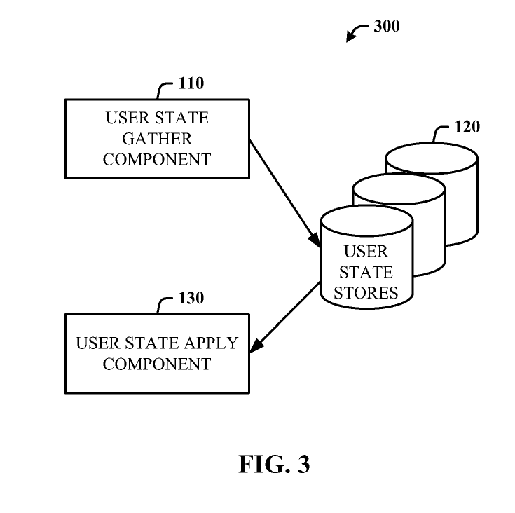

FIG. 3 illustrates a computer-implemented system 300 that facilitates user state migration. The system 300 includes a user state gather component 110 and a user state apply component 130, as discussed previously. However, the system 300 includes a plurality of user state stores 120 that are linked together. In this manner, each volume (e.g., hard drive) having file(s) to be migrated has an associated user state store 120 that stores hard links to files on the particular volume included in user state migration.

In one embodiment, the system 300 is employed with the NTFS file system in which hard links are not permitted to persist across system volumes. Since a separate user state store 120 is used for each volume employed in the migration, with the plurality of user state stores 120 linked together, migration can be performed for a plurality of system volumes.

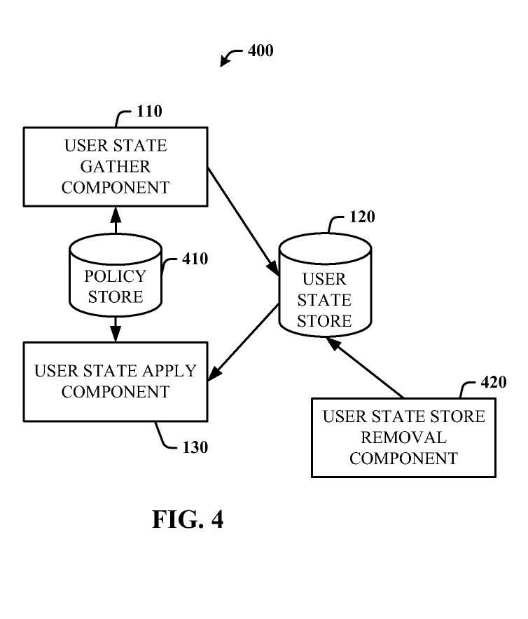

FIG. 4 illustrates a computer-implemented system 400 that facilitates user state migration. Accessing locked files is a common problem during any migration. Hard link(s) can be created to file(s) that are locked for editing and that cannot be copied into a temporary store. However, in one embodiment, hard link(s) created under these conditions cannot be deleted until after the lock has been lifted.

Conventionally, one of the challenges of performing a migration is the need to acquire full read access to user document(s) included in the migration. When a user is using a computer, this is often not practical. For example, application(s), such as Outlook®, that are often running on the computer, also often keep a file on the hard disk open. In order to prevent another process from grabbing a possibly incomplete version of the file, Outlook® locks the file in such a way that no other process can access it until Outlook® closes the file. However, this lock only applies to copying the file, not creating a hard link to the file. Thus, a migration dependent on copying files to a temporary store generally aborts upon encountering a locked file; however, a migration dependent on creating hard links can proceed.

In one example, after a hard link has been created to a locked file, that hard link cannot be deleted until the lock has been removed. In many wipe-and-load scenarios, the inability to delete hard links until the lock has been removed is not problematic since the operating system is wiped from the computer in the pre-installation environment (e.g., Windows® PE).

However, during migration script development an engineer may desire to invoke the user migration system more than once (e.g., to verify that scripts are functioning as expected). Hard links to file(s) that are locked generally require that the application locking the file(s) be closed before the hard links can be deleted. Thus, in one embodiment, a stored policy 410 can be specified (e.g., in XML) that allows a user (e.g., IT engineer) precise control over when hard link(s) are created to locked files (e.g., identify file(s) to include and/or exclude from use of hard links). The user state gather component 110 can use the policy 410 when determining whether to store a hard link to a locked file. For example, during migration script development, the policy 410 can provide for hard link to not be used for locked file(s) (e.g., which emulates conventional behavior when a conventional copy-based migration is performed).

In another embodiment, optionally, a user state store removal tool 420 enables user state store(s) 120 (e.g., hard link temporary store(s)) to be deleted upon the computer's next reboot, when the files are no longer locked.

In one example, certain operating system files that are locked. In this example, a hard link created to one of these will not be able to be deleted. Thus, in this example, the user state gather component 110 prevents creation of hard links to pre-specified operating system file(s).

Those skilled in the art will recognize that while state migration with file system hard links has been discussed, the hereto appended claims are intended to encompass aliasing as a technique for state migration in software servicing.

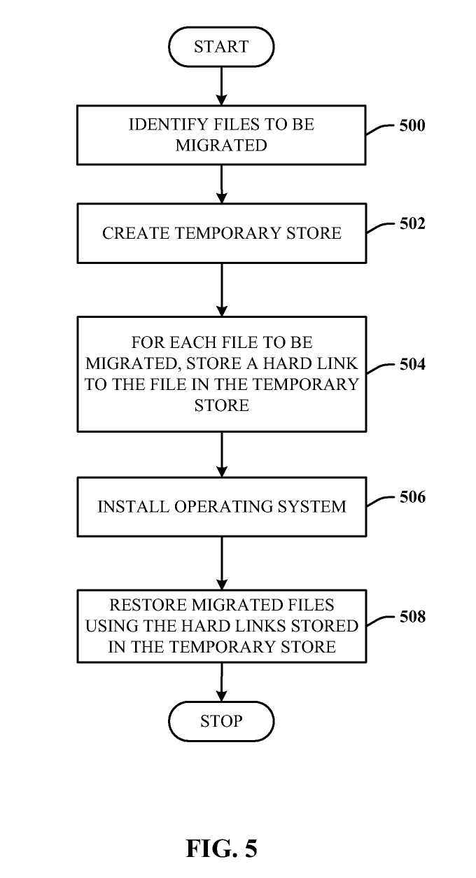

FIG. 5 illustrates a computer-implemented method of performing user state migration. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 500, file(s) to be migrated are identified. At 502, a temporary store (e.g., user state store 120) is created. If the files to be migrated are on two or more local volumes, temporary stores can be created on each volume, and the temporary stores linked together.

At 504, for each file to be migrated, a hard link to the file is stored in the temporary store. At 506, an operating system is installed. At 508, the migrated file(s) are restored using the hard links stored in the temporary store.

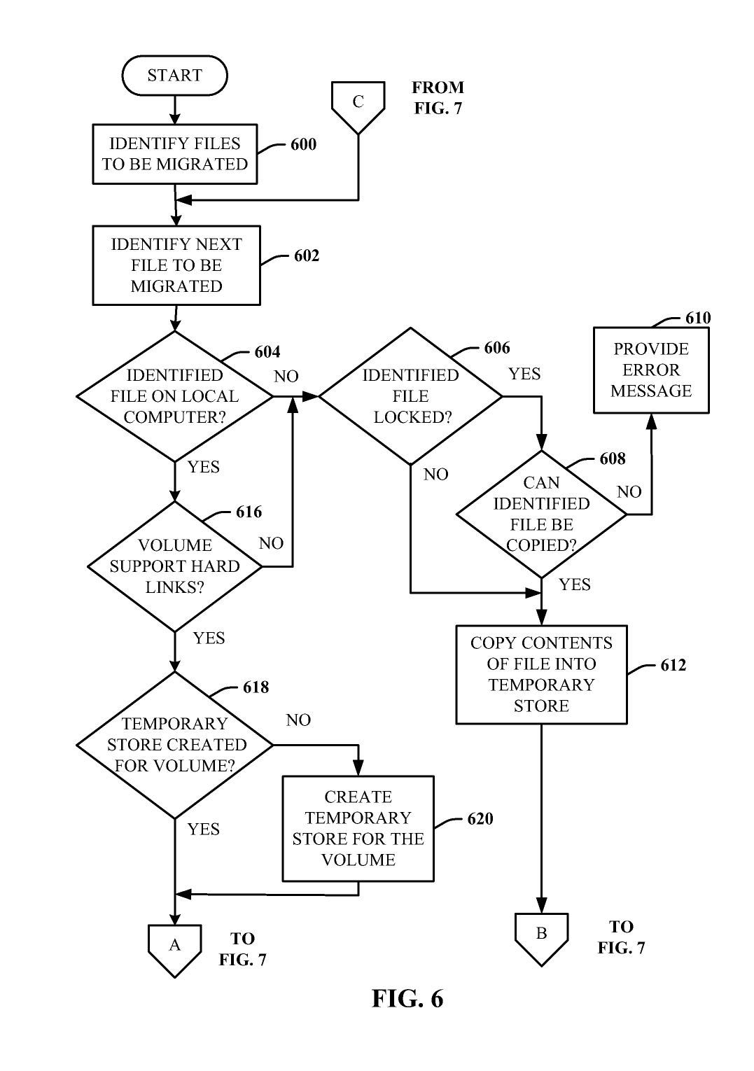

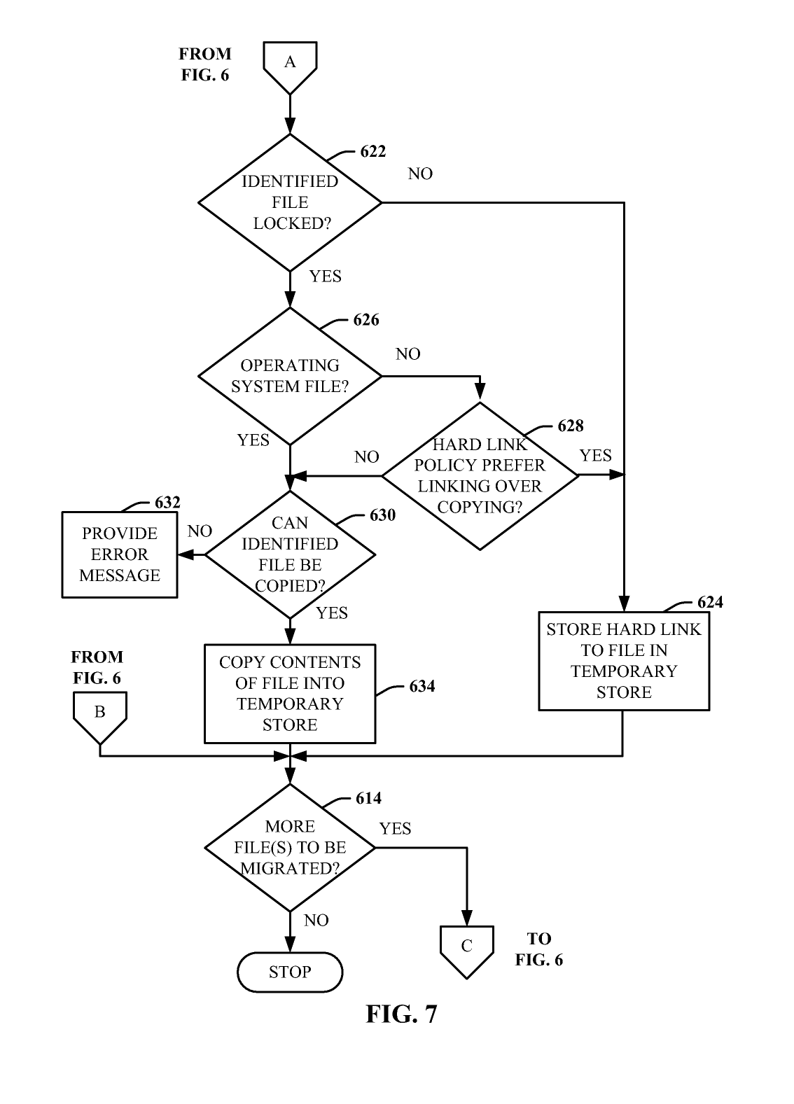

FIGS. 6 and 7 illustrate a computer-implemented method of gathering user state. At 600, file(s) to be migrated are identified. At 602, a next file to be migrated is identified. At 604, a determination is made as to whether the identified file is stored on a local computer system. If the determination at 604 is NO, at 606, a determination is made as to whether the identified file is locked. If the determination at 606 is YES, at 608, a determination is made as to whether the identified file can be copied. If the determination at 608 is NO, at 610, an error message is provided and the method ends.

If the determination at 608 is YES, at 612, the contents of the file are copied into a temporary store and continue processing at 614. If the determination at 606 is NO, processing continues at 612.

If the determination at 604 is YES, at 616, a determination is made as to whether a volume associated with the identified file supports hard links (e.g., NTFS). If the determination at 616 is NO, processing continues at 606. If the determination at 616 is YES, at 618, a determination is made as to whether a temporary store has been created for the volume associated with the identified file. If the determination at 618 is NO, at 620, a temporary store is created for the volume associated with the identified file and processing continues at 622. If the determination at 618 is YES, at 622, a determination is made as to whether the file is locked. If the determination at 622 is NO, at 624, a hard link to the identified file is stored in the temporary store for the volume associated with the identified file and processing continues at 614.

If the determination at 622 is YES, at 626, a determination is made as to whether the identified file is an operating system file. If the determination at 626 is NO, at 628, at determination is made as to whether a hard link store policy indicates a preference to linking over copying. If the determination at 628 is YES, processing continues at 624. If the determination at 628 is NO, processing continues at 630.

If the determination at 626 is YES, at 630, a determination is made as to whether the identified file can be copied into the temporary store. If the determination at 630 is NO, at 632, an error message is provided and the method ends.

If the determination at 630 is YES, at 634, the contents of the file are copied into the temporary store and processing continues at 614. At 614, a determination is made as to whether there are more file(s) to be migrated. If the determination at 614 is YES, processing continues at 602. If the determination at 614 is NO, no further processing occurs.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

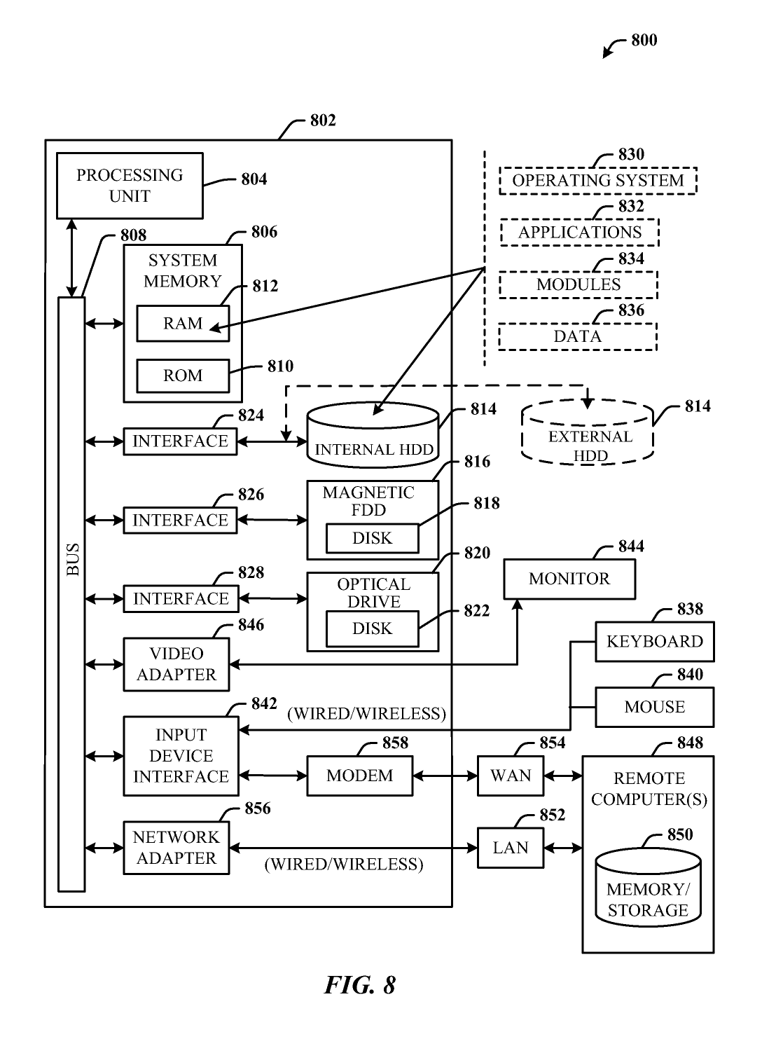

Referring now to FIG. 8, there is illustrated a block diagram of a computing system 800 operable to execute the disclosed architecture facilitating migration of user state with file system hard links. In order to provide additional context for various aspects thereof, FIG. 8 and the following discussion are intended to provide a brief, general description of a suitable computing system 800 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary computing system 800 for implementing various aspects includes a computer 802, the computer 802 including a processing unit 804, a system memory 806 and a system bus 808. The system bus 808 provides an interface for system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in the read-only memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The internal hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the disclosed architecture can be implemented with various commercially available operating systems or combinations of operating systems.

A user can enter commands and information into the computer 802 through one or more wired/wireless input devices, for example, a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

The computer 802 can include a computer-implemented system 100 (not shown) that facilitates user state migration using file system hard links. For example, the files having user state to be migrated can be stored on the hard disk drive 814. The system 100 can store hard links to the files on the hard disk drive 814.

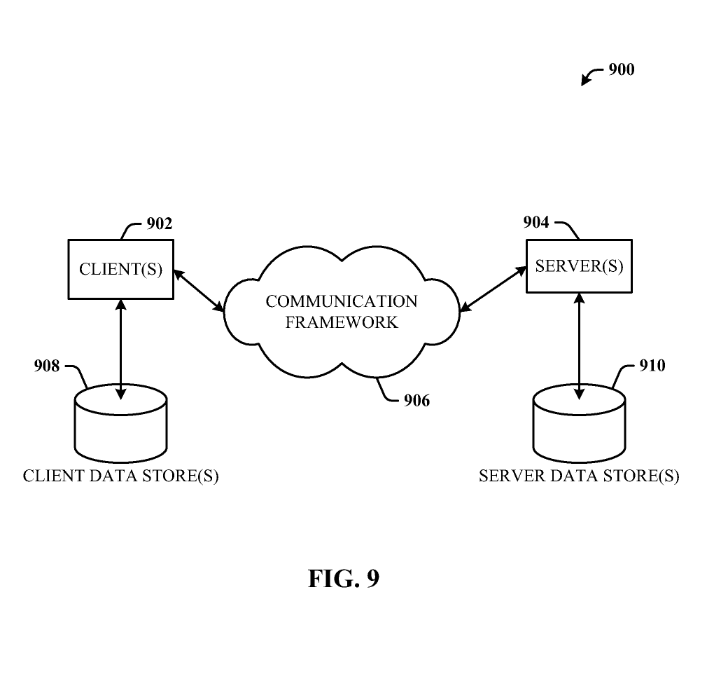

Referring now to FIG. 9, there is illustrated a schematic block diagram of an exemplary computing environment 900 that facilitates user state migration. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates user state migration, comprising:
a user state gather component that receives information associated with user state, the user state gather component storing a hard link to a file in a user state store, wherein user state comprises the file; and, a user state apply component that restores user state based on the hard link to the file stored in the user state store.

2. The system of claim 1, wherein the file is locked for editing and contents of the file are not permitted to be copied into the user state store.

3. The system of claim 2, wherein the user state gather component uses a stored policy to determine whether to store the hard link to the locked file.

4. The system of claim 1, wherein the user state gather component stores hard links for a plurality of files in the user state store.

5. The system of claim 4, further comprising a plurality of user stores, wherein a particular user store is associated with a volume of a particular file and the plurality of user stores are linked together.

6. The system of claim 4, wherein the user state gather component does not store a hard link to one or more pre-specified operating system files.

7. The system of claim 1, wherein the user state store further stores contents of another file.

8. The system of claim 1, further comprising a user state store removal tool that enables the user state store to be deleted upon a next reboot of a computer associated with the system.

9. The system of claim 1, wherein the hard link is a directory entry for the file.

10. The system of claim 1, wherein the user state further comprises a setting.

11. A computer-implemented method of performing user state migration, comprising:
for each of a plurality of files to be migrated, storing a hard link to the file in a temporary store;
installing an operating system; and
restoring the migrated files using the hard link.

12. The method of claim 11, further comprising identifying the files to be migrated.

13. The method of claim 11, further comprising:
if the files to be migrated are on two or more local volumes, creating temporary stores on each local volume; and,
linking the temporary stores together.

14. A computer-implemented method of performing user state migration, comprising:
identifying a plurality of files to be migrated;
identifying a next file to be migrated;
determining whether a volume associated with the identified next file supports hard links;
determining whether the identified next file is locked, the volume associated with the identified next file supports hard links; and,
storing a hard link to the identified next file, if the identified next file is not locked.

15. The method of claim 14, further comprising:
determining whether a temporary store has been created for the volume associated with the identified next file; and,
creating the temporary store for the volume associated with the identified next file, if the temporary store has not been created for the volume associated with the identified next file.

16. The method of claim 14, further comprising:
determining whether the identified next file is on a local computer;
if the identified next file is not on the local computer:
determining whether the identified next file is locked;
determining whether the identified next file can be copied copying contents of the identified next file, if the identified next file is not locked and the identified next file can be copied; and,
providing an error message, if the identified next file cannot be copied.

17. The method of claim 14, further comprising:
determining whether the identified next file is a pre-specified operating system file;
if the identified next file is the pre-specified operating system file:
determining whether the identified next file can be copied;
copying contents of the identified next file, if the identified next file can be copied; and,
providing an error message, if the identified next file cannot be copied.

18. The method of claim 14, further comprising:
determining whether a policy a hard link store policy provides a preference to linking over copying;
copying contents of the identified next file, if the policy does not provide a preference to linking over copying; and,
storing a hard link to the file in the temporary store, if the policy provides a preference to linking over copying.

19. The method of claim 14, further comprising linking a plurality of temporary stores together.

20. The method of claim 14, wherein the hard link is a directory entry for the file.
